(19) United States
(12) Patent Application Publication
(10) Pub. No.: US 2010/0235843 A1
(43) Pub. Date: Sep. 16, 2010

(54) IMPROVEMENTS RELATING TO DISTRIBUTED COMPUTING

(75) Inventors: Jamil Appa, Bristol (GB); David William Fin Standingford, Bristol (GB)

Correspondence Address: BUCHANAN, INGERSOLL & ROONEY PC, POST OFFICE BOX 1404, ALEXANDRIA, VA, 22313-1404, US

(73) Assignee: BAE SYSTEMS plc., London (GB)

(21) Appl. No.: 12/160,589

(22) PCT Filed: Apr. 4, 2008
(86) PCT No.: PCT/GB08/50243

§ 371 Date: Jul. 10, 2008

(30) Foreign Application Priority Data
Apr. 4, 2007 (EP) 07270018.0
Apr. 4, 2007 (GB) 0706582.4

(51) Int. Cl. G06F 9/46; G06F 15/173

(52) U.S. Cl. 718/104; 709/226

(57) ABSTRACT

There is provided a computer-implemented method of allocating a task to a set of distributed computing resources (102-114). The method includes obtaining (604) resource data (200) describing a set of distributed computing resources and obtaining (602) task data (400) describing a computing task to be performed. The method then selects (606) at least one of the distributed computing resources for performing the task based on the obtained description of the task.

The present invention relates to distributed computing.

Currently, when computer applications are submitted to distributed computing networks/resources, standard modes of communication such as TCP/IP and MPI are used. TCP/IP does not provide for any scheduling or management of latency in the network, and MPI is only used to synchronise communications between parallel processes.

When parallel or otherwise distributed computer jobs are submitted to a network, there are no existing ways to manage the communications other than by making an a-priori assessment of the optimal partitioning (division) of the job, and assuming a level of competition for resources from other applications, users or processes. There is also no way to make use of a new resource that is added, or adapting to changes in topology or network performance.

According to a first aspect of the present invention there is provided a computer-implemented method of allocating a task to a set of distributed computing resources, the method including: obtaining resource data describing a set of distributed computing resources; obtaining task data describing a computing task to be performed; and selecting at least one of the distributed computing resources for performing the task based on the obtained description of the task.

According to another aspect of the present invention there is provided apparatus for allocating a task to a set of distributed computing resources, the apparatus including: a device configured to obtain resource data describing a set of distributed computing resources; a device configured to obtain task data describing a computing task to be performed; and a device configured to select at least one of the distributed computing resources for performing the task based on the obtained description of the task.

According to a further aspect of the present invention there is provided a computer-implemented method of generating resource information describing a set of distributed computing resources in a network, the method including: selecting a first resource in the network; interrogating the resource to determine its characteristics; storing data describing the characteristics; and selecting at least one further resource that is in communication with the first resource and repeating the interrogating and storing steps for the at least one further resource. According to another aspect of the invention there is provided apparatus configured to perform this method.

According to yet another aspect of the present invention there is provided a computer-implemented method of generating task information describing a computing task to be performed using distributed computing resources, the method including analysing source or executable code describing the task to obtain statistics (or estimated statistics) of the computational requirements of the task. According to another aspect of the invention there is provided apparatus configured to perform this method.

According to further aspects of the present invention there are provided computer program products comprising computer readable medium, having thereon computer program code means, when the program code is loaded, to make the computer execute methods substantially as described herein.

Whilst the invention has been described above, it extends to any inventive combination of the features set out above or in the following description. Although illustrative embodiments of the invention are described in detail herein with reference to the accompanying drawings, it is to be understood that the invention is not limited to those precise embodiments. As such, many modifications and variations will be apparent to practitioners skilled in this art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings, in which:

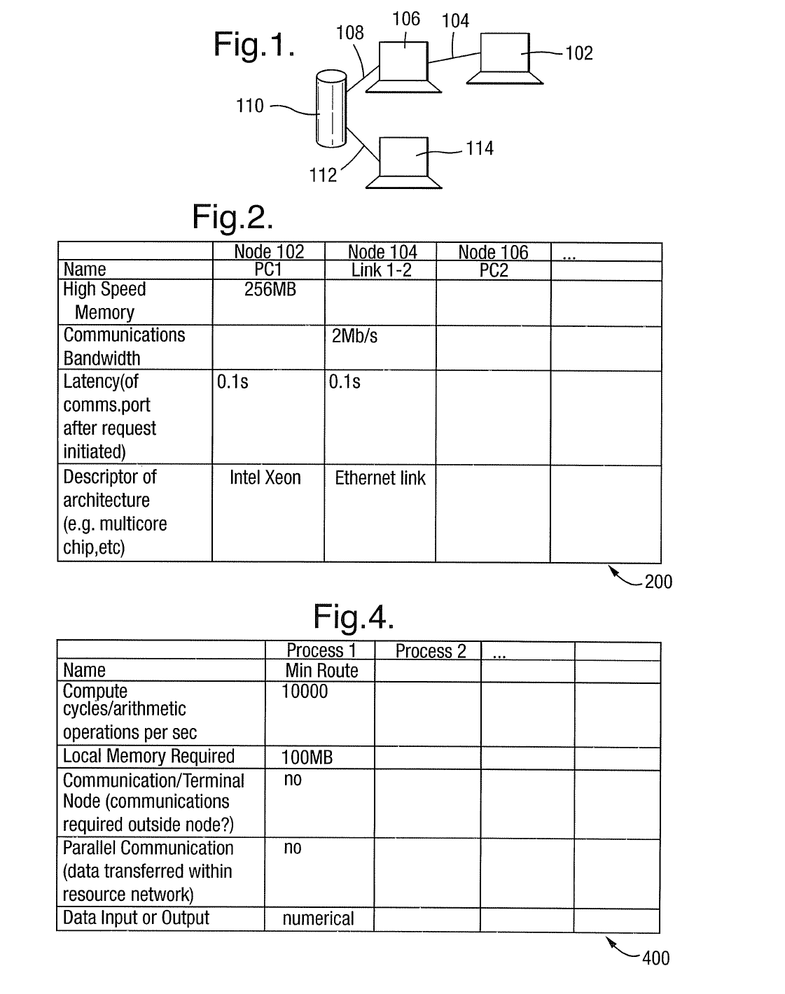

FIG. 1 illustrates schematically an example of a set of distributed computing resources connected over a network;

FIG. 2 is a graphical representation of data describing distributed computing resources;

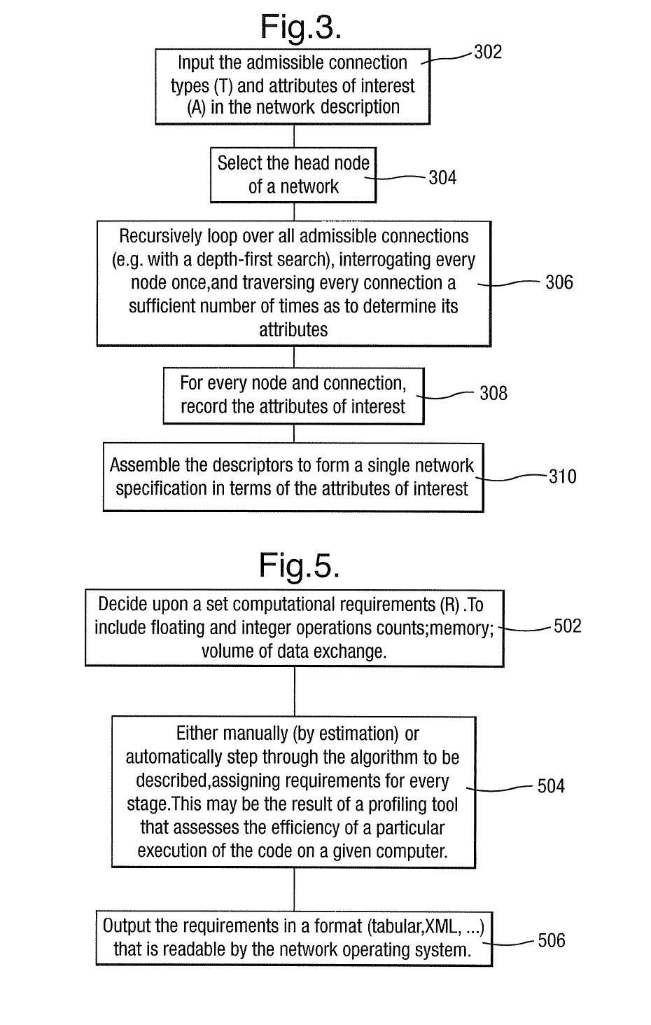

FIG. 3 illustrates schematically steps performed in order to generate the data of FIG. 2;

FIG. 4 is a graphical representation of data describing a computing task;

FIG. 5 illustrates schematically steps performed in order to generate the data of FIG. 4; and

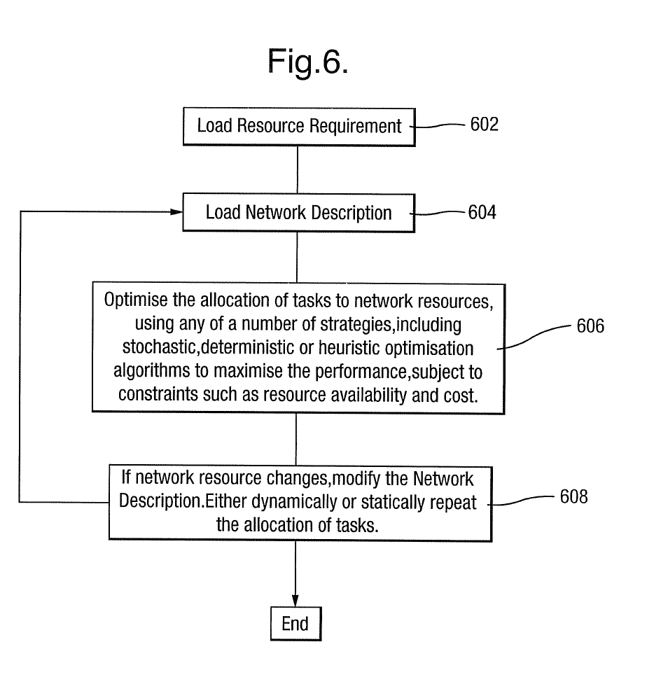

FIG. 6 illustrates schematically steps performed in order to select which distributed computing resources will be used for performing the task.

FIG. 1 is a diagram of a set of resources that are available for performing a distributed computing task. The resources comprise various hardware devices that are connected together over a network. It will be understood that the basic arrangement shown in the Figure is exemplary only and many variations are possible.

In the shown example of FIG. 1 a first computing device 102 is connected over a communications link 104 to a second computing device 106. It will be appreciated that the computing devices can take several forms, e.g. be general purpose desktop personal computers running software that makes them suitable for executing distributed tasks, or they may be more specialised hardware. Similarly, the communications links can take several forms, e.g. a Local Area Network or Ethernet link, and can be in wired or wireless form. The second computing device is connected over link 108 to a storage device 110 (e.g. an external hard drive or Redundant Array of Independent Disks storage arrangement). The storage device 110 is connected via link 112 to a third computing device 114.

As will be known to the skilled person, the various nodes (e.g. computing/storage devices) in the network and the links between them can have many different individual characteristics. Conventionally, users often have to know, estimate or look up these characteristics before selecting which elements will be used to perform a distributed computing task. This is prone to human error and will not usually result in optimal distribution of a task to the most suitable resources. Embodiments of the present system provide the following features in an attempt to solve this problem:
1. A method of describing an IT network for the purposes of allocating and managing distributed compute jobs, in sufficient detail to permit optimisation with respect to processor power and local storage, including though not limited to: cache memory, RAM and local disks; network bandwidth and latency; guaranteed quality of service and cost per resource.
2. A mechanism for automatically determining the network characteristics as defined at 1. above. This may be a daemon process that resides on the network and responds to queries, posts information on a proxy or polls resource on demand; a programme that is run on the network or a process that references published or stored information relevant to the network concerned.
3. A method of describing a process to be run on an IT network, including though not limited to operation counts, communication bandwidth and scheduling, memory requirements, input-out operations and links to external processes.
4. A mechanism for the automated determination of the elements of 3. above from a process description, such as UML meta-code, source code or object code.

One or more computer executing code for implementing processes 1.-4. above can be used. That computer(s) may be part of the network that will be used for executing the distributed computing task, or may be separate from it. The processes 1.-4. may be part of a single application, or may be separated into separate modules, e.g. a resource description-building program, a task description-building program, etc.

FIG. 2 schematically illustrates a data structure 200 that can be used for the purpose outlined at 1. above. The data structure includes a set of variables that represent various characteristics of the resources, which can be processing devices, storage devices or communications links. Typically, the resource data describes characteristics of the distributed computing resources such as memory; communications bandwidth; processing speed; data transfer speed, but it will be understood that the variables used in the Figure are exemplary only and other characteristics could be described in addition to, or instead of, those shown. For instance, variables representing characteristics of a processor could be included that specify that it has a specialist functionality, such as being very fast at matrix operations. Characteristics of I/O devices could also be represented, e.g. the type of the device and/or the type of I/O with which they operate, e.g. keyboard, haptic glove, visualisation wall/screen, virtual reality devices. The data structure can be filled-in/edited using a suitable user-interface if desired. In some cases, the data structure may be implemented using a format well known to programmers so that it is easy to complete by using a file editor or the like. The description is intended to be general-purpose and easy to adapt to include new hardware resources, etc.

FIG. 3 illustrates schematically an example of steps that are performed in order to generate the description of the available resources. It will be appreciated that the process steps shown in the Figures are exemplary only and that variations are possible, e.g. some of the steps could be omitted and/or their order/repetition could be varied. At step 302, a description of the admissible connection types and resource attributes of interest in terms of deciding what network resources are to be used may be input. For instance, the admissible resources described may specify that only nodes/connections having processing/data transfer speeds over a certain threshold are to be used. This description can be obtained from a user who may have knowledge of the task to be performed and/or the networked resources (and their current availability, etc), or may be obtained from default values set by the resource description-building program.

At step 304, one of the network nodes is selected as a “head node” that will be the starting point for a processes that builds the description of the available resources. This head node data may be selected/input by the user or retrieved from a store, e.g. the resource description-building program has been set up with default head node data for one or more network setups.

Steps 306 and 308 can be performed as part of a loop of steps. Starting with the selected head node, the resource description-building program interrogates the connection(s) and other node(s) in communication with that node and generates data describing their attributes. That description data is then stored, e.g. in the data structure 200 shown in FIG. 2, at step 310. Steps 306 and 308 are repeated for any other nodes/connections found that are in communication with the node/connection that has just been interrogated until all the nodes/connections in the network have been covered. The skilled person will appreciate that there are several ways of achieving this, e.g. recursively traversing the network using a depth-first search type algorithm starting with the head node.

FIG. 4 schematically illustrates a data structure 400 that can be used for the purpose outlined at 3. above. The data structure includes a set of variables that represent various characteristics of the task to be distributed. Typically, the task data describes the task using characteristics such as floating point operations count; integer operations count; memory required; volume of data transfer. However, it will be understood that these variables and the ones shown in FIG. 4 are exemplary only and other characteristics could be described in addition to, or instead of, those shown.

FIG. 5 illustrates schematically an example of steps that are performed in order to generate the description of the task. At step 502 a set of computational requirements are obtained. These can be retrieved from a store (default values), or a user may select them, possibly with knowledge of the distributed computing task to be performed and/or of the (available) network resources. For example, the user could select one or more requirements from a list/menu of typical computational requirements. A non-exhaustive list of such requirements includes floating point operations count, integer operations count, memory needed, volume of data exchange (between nodes).

At step 504 the task to be performed is analysed so as to assess its computational requirements (in terms of those obtained at step 502). It will be appreciated that there are several ways of doing this. For example, the overall task may be broken down step-by-step, or into sections/groups of steps, and the number of integer operations required by a particular step/section may be recorded using a program that analyses the task source or executable code. Alternatively, a user may analyse the code to produce an estimate. A total of all the integer operations for the entire task can then be summated and the process can then be repeated for the other computational requirements. At step 506 an output representing the results of step 504 is produced. This can be in any suitable format, e.g. XML, preferably one that can be read by the network operating system and a program for allocating network resources to perform the task.

FIG. 6 illustrates schematically an example of steps that can performed in order to select which of the distributed computing resources described in the data structure will be used for performing a task described by a task data structure. At step 602 the task description data generated using the steps of FIG. 5 is loaded and at step 604 data describing network resources generated using the steps of FIG. 3 is loaded.

At step 606 the task is allocated to at least one of the network resources. It will be appreciated that there are several methods of doing this. For example, a resource-allocating program can use conventional algorithms, such as stochastic, deterministic or heuristic optimisation algorithms to allocate parts of the task to various resources. The skilled person will be able to find/derive suitable techniques from the field of Operations Research. These can include linear and integer programme techniques for both discrete (where the variables can take on only a set of pre-defined values) and continuous (where the variables are any (vector of) real-valued numbers) optimisation methods. Nonlinear techniques may also be used.

A non-exhaustive list of examples of suitable Operations Research techniques include: Branch and Bound (technique for solving discrete optimization problems by organizing the search in a tree. In each node of the tree, bounds on the objective are computed, which are used to exclude parts of the tree from the search); Dynamic Programming (method for solving dynamic (i.e. with time structure) optimization problems using recursion); Integer Programming (optimization where the variables only may take integer values, i.e. 0, 1, 2, 3, . . . ); Lagrangian Relaxation (transformation of an optimization problem, where constraints are moved to the objective, multiplied by auxiliary parameters, so called Lagrangian multipliers. These multipliers become variables in the so called dual problem); Linear Programming (optimization where objective function and constraints are linear); Simplex Algorithm (algorithm for optimization without constraints, that only uses objective function values (i.e. no derivatives). The objective is calculated in the vertices of a simplex, and a new vertex is produced by mirroring the worst vertex in the plane spanned by the other vertices. The Nelder-Mead simplex method is very popular because it is easy to understand and implement, and does not require derivatives to allocate parts of the task to various resources); Quadratic Programming (optimisation where the objective function is nonlinear and the constraints are linear). A suitable optimisation scheme may be a combination of any of the above (and/or other) schemes and so-called heuristics which require knowledge about the particular problem being solved. For distributing the processing task to the networked resources, it is likely that a combination of Dynamic Programming and Integer Programming will be best, including Heuristics to account for the existing knowledge (normally based on records of past performance) of the interpretation of the integer values in directing network resource.

Factors such as resource availability and cost may also be taken into account by the algorithm. The method can include optimisation algorithms such as genetic algorithms; simulated annealing; operational analysis techniques; heuristics based on prior knowledge; machine learning techniques such as neural networks and Artificial Intelligence, all of which will be familiar to the skilled person.

Step 608 can be performed if the network resources change during execution of the task. For instance, if a processor is urgently required for performing another task, or becomes unavailable for some other reason then resource-allocating program analyses the remaining available resources (based on the descriptions obtained) and attempts to re-allocate part of the distributed task to another suitable resource. This re-allocation can be performed dynamically or statistically. If a network-distribute programme is already running, then it can be undesirable to stop (or pause) that while reallocating resource for performing a task because resource availability (or cost) may change on an ad hoc basis. Dynamic re-allocation can allow the process to continue substantially uninterrupted whilst changing the forward resource allocation profile (i.e. the result of the allocation optimisation process based on the task description and the resource description). The optimisation techniques described above are capable of enabling both static and dynamic planning and so the choice of technique can be dictated by the capability of the network Operating System.

A tangible technical benefit provided by the inventive methods described above is that it is no longer necessary for an end-user to guess the availability of resource prior to submitting a job, or to understand fully the resource requirements for unfamiliar code. The limitations of TCP/IP in optimising a communication path are addressed by this invention because of the richer description of the resource requirements that a process is able to provide to the operating system and specialist sub-components.

1. A computer-implemented method of allocating a task to a set of distributed computing resources, the method including:
obtaining resource data describing a set of distributed computing resources;
obtaining task data describing a computing task to be performed; and
selecting at least one of the distributed computing resources for performing the task based on the obtained description of the task.

2. A method according to claim 1, wherein the resource data and/or the task data is in a format that is readable by an operating system of a network over which the distributed computing resources are connected.

3. A method according to claim 1, wherein the resource data describes characteristics of a said distributed computing resource in terms of at least one characteristic that has been set by a user.

4. A method according to claim 1, wherein the task data describes characteristics of the task in terms of at least one computational requirement that has been set by a user.

5. A method according to claim 1, wherein the selection of at least one of the distributed computing resources uses an algorithm based on Dynamic Programming and Integer Programming techniques with heuristics that account for existing knowledge of performance of the distributed computing resources.

6. A method according to claim 1, wherein the resource data is obtained using steps of:
selecting a first resource in the network;
interrogating the resource to determine its characteristics;
storing data describing the characteristics; and
selecting at least one further resource that is in communication with the first resource and repeating the interrogating and storing steps for the at least one further resource.

7. A method according to claim 6, wherein the resource data describes characteristics of a said distributed computing resource in terms of at least one characteristic that has been set by a user, and the characteristics stored for a said resource correspond to the at least one characteristic set by the user.

8. A method according to claim 1, wherein the task data is obtained by analyz*-ing source or executable code describing the task to obtain statistics (or estimated statistics) of the computational requirements of the task.

9. A method according to claim 8, wherein the task data describes characteristics of the task in terms of at least one computational requirement that has been set by a user, and the computational requirements for which statistics/estimates are obtained correspond to the at least one computational requirement set by the user.

10. A computer program comprising program code means for performing the method steps of claim 1 when the program is run on a computer.

11. A computer program product comprising program code means stored on a computer readable medium for performing the method steps of claim 1 when the program is run on a computer.

12. A method substantially as hereinbefore described with reference to the accompanying drawings.

13. Apparatus for allocating a task to a set of distributed computing resources, the apparatus including:
a device configured to obtain resource data describing a set of distributed computing resources;
a device configured to obtain task data describing a computing task to be performed; and
a device configured to select at least one of the distributed computing resources for performing the task based on the obtained description of the task.

14. Apparatus substantially as hereinbefore described with reference to the accompanying drawings.

15. A method according to claim 2, wherein the resource data describes characteristics of a said distributed computing resource in terms of at least one characteristic that has been set by a user.

16. A method according to claim 15, wherein the task data describes characteristics of the task in terms of at least one computational requirement that has been set by a user.

17. A method according to claim 16, wherein the selection of at least one of the distributed computing resources uses an algorithm based on Dynamic Programming and Integer Programming techniques with heuristics that account for existing knowledge of performance of the distributed computing resources.

18. A method according to claim 17, wherein the resource data is obtained using steps of:
selecting a first resource in the network;
interrogating the resource to determine its characteristics;
storing data describing the characteristics; and
selecting at least one further resource that is in communication with the first resource and repeating the interrogating and storing steps for the at least one further resource.

19. A method according to claim 18, wherein the resource data describes characteristics of a said distributed computing resource in terms of at least one characteristic that has been set by a user, and the characteristics stored for a said resource correspond to the at least one characteristic set by the user.

20. A method according to claim 19, wherein the task data is obtained by analyzing source or executable code describing the task to obtain statistics (or estimated statistics) of the computational requirements of the task.
